(19) United States
(12) Patent Application Publication
(10) Pub. No.: US 2025/0335636 A1
(43) Pub. Date: Oct. 30, 2025

(54) ELEVATING PERMISSION TO A PROCESS TO SUBMIT A COMMAND WHEN THE PROCESS DID NOT SATISFY A SECURITY REQUIREMENT FOR THE COMMAND

(71) Applicant: INTERNATIONAL BUSINESS MACHINES CORPORATION, ARMONK, NY (US)

(72) Inventors: Beth Ann Peterson, Tucson, AZ (US); Matthew G. Borlick, Tucson, AZ (US); Lokesh Mohan Gupta, Tucson, AZ (US); Rashmi Chandra, Santa Clara, CA (US); Richard Gorowsky, Tucson, AZ (US); Stefan Lehmann, Tucson, AZ (US)

(21) Appl. No.: 18/647,520

(22) Filed: Apr. 26, 2024

(51) Int. Cl. G06F 21/62

(52) U.S. Cl. CPC G06F 21/629

(57) ABSTRACT

Provided are a computer program product, system, and method for elevating permission to a process to submit a command when the process did not satisfy a security requirement for the command. A command is received from a first computer process to perform an operation effecting a protected resource in the computing system. A determination is made whether the command satisfies a security requirement of the protected resource. In response to determining that the command does not satisfy the security requirement of the protected resource, transmitting information indicating that the command did not satisfy the security requirement for the protected resource to one of the first computer process or a second computer process controlling whether to elevate permission to the protected resource. The first computer process is provided elevated permission to perform the command to affect the protected resource in response to the second computer process providing the elevated permission.

### BACKGROUND OF THE INVENTION

### 1. Field of the Invention

The present invention relates to a computer program product, system, and method for elevating permission to a process to submit a command when the process did not satisfy a security requirement for the command.

### 2. Description of the Related Art

Interfaces to a control unit may require security authentication to submit certain commands, such as multi-factor authentication and remote authentication via a graphical user interface (GUI) or command line interface (CLI). If a command fails to satisfy a security requirement, then the process or system that submitted that command may experience disruption to operations due to the failed command.

### SUMMARY

Provided are a computer program product, system, and method for elevating permission to a process to submit a command when the process did not satisfy a security requirement for the command. A command is received from a first computer process to perform an operation effecting a protected resource in the computing system. A determination is made whether the command satisfies a security requirement of the protected resource. In response to determining that the command does not satisfy the security requirement of the protected resource, transmitting information indicating that the command did not satisfy the security requirement for the protected resource to one of the first computer process or a second computer process controlling whether to elevate permission to the protected resource. The first computer process is provided elevated permission to perform the command to affect the protected resource in response to the second computer process providing the elevated permission for the command from the first computer process to affect the protected resource.

### BRIEF DESCRIPTION OF THE DRAWINGS

FIG. 1 illustrates an embodiment of a computing environment.

FIG. 2 illustrates an embodiment of an instance of a protected resource permissions.

FIG. 3 illustrates an embodiment of operations to establish protection when creating a protected resource.

FIG. 4 illustrates an embodiment of a handshaking protocol between a host and storage controller to establish whether an elevated permission protocol is supported in the host and the storage controller.

FIG. 5 illustrates an embodiment of operations to determine whether a command from a host satisfies a security requirement and whether to implement the elevated permission protocol.

FIG. 6 illustrates an embodiment of operations to process a request to elevate permissions for a host to submit a command impacting a protected resource that did not satisfy a security requirement.

FIG. 7 illustrates an embodiment of operations to secure a protected resource when elevated permission has not been granted for a command not satisfying a security requirement.

FIG. 8 illustrates a computing environment in which the components of FIG. 1 may be implemented.

### DETAILED DESCRIPTION

Security authentication methods, such as Multi-Factor Authentication via a GUI or CLI, provide interfaces to a storage controller. Multiple vectors, i.e., commands, from different hosts and processes, may use these authentication methods to access a storage controller to do the same work (such as to establish a point-in-time copy) Although there may be assumptions that a customer will apply properly administrative protections so as not to overlay a point-in-time copy with another point-in-time copy or to delete a volume in a point-in-time copy relationship, a problem may arise when there are multiple different vectors, i.e., commands, into the host such that the less-secure vectors may perform operations that negatively impact resources configured in the host, such as point-in-time copies. Further, a malicious insider may gain access to the weakest link to issue harmful commands.

Described embodiments provide improvements to computer technology for managing security requirements for a protected resource and managing permission to the protected resource by commands that may have an impact on the protected resource by providing an elevated permission protocol to allow elevation of permissions to execute a command impacting a protected resource. The elevated permission protocol provides a protocol to grant a host submitting a command permission to submit the command if the host does not satisfy the security requirements for a protected resource impacted by the command. This provides protection from commands that may impact a protected resource while at the same time providing a protocol to elevate permission to the host to submit the command to avoid disruptions to the host operations.

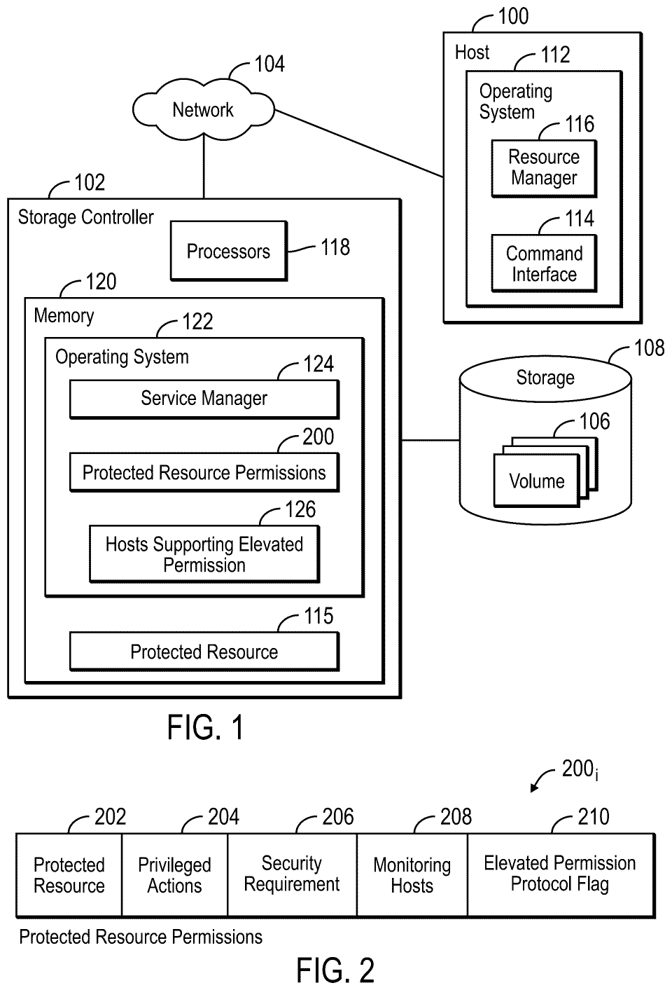

FIG. 1 illustrates an embodiment of a storage environment. A host 100, which represents one of a plurality of hosts, may submit Input/Output (I/O) requests to a storage controller 102 over a network 104 to access data at volumes 106 (e.g., Logical Unit Numbers, Logical Devices, Logical Subsystems, etc.) in a storage 108. The volumes 106 may be stored across a plurality of storage devices in a Redundant Array of Independent Disks (RAID) or Just a Bunch of Disk (JBOD) configuration. The hosts 100 include an operating system 112 having a command interface 114 to allow the hosts 100 to submit commands to the storage controller 102 that may perform an operation to affect a protected resource 115 implemented by the storage controller 102. The operating system 112 may further include a resource manager 116 to allow the host to establish a protected resource 115. For instance, the protected resource 115 may comprise a copy relationship, such as a point-in-time copy, between volumes 106 in the storage 108, a representation of a volume 115 created by the operating system 112. a database, shared data structure, hardware resources, etc.

The storage controller 102 includes one or more processors 118 and a memory 120. The processors 118 may comprise a separate central processing unit (CPU), one or a group of multiple cores on a single CPU, or a group of processing resources on one or more CPUs. The memory 120 includes an operating system 122 to manage commands from the hosts 100 to perform operations with respect to volumes 106 configured in the storage 108. The operating system 122 includes a service manager 124 to manage services offered in the storage controller 102, such as copy services, computational resources, artificial intelligence resources, and manage commands from host command interfaces 114 that could affect protected resources 115 created by the services, such as storage, point-in-time copy relationships, etc. The service manager 124 may maintain protected resource permissions 200 having information on security requirements for privileged commands that could affect a defined protected resource. The service manager 124 maintains information on hosts 100 supporting elevated permission 126.

In certain embodiments, the storage controller 102 may comprise an enterprise storage controller, such as the International Business Machines Corporation (IBM®) DS8000™ storage controller or storage controllers from other vendors. The hosts 100 may comprise an enterprise host system that includes an operating system such as, but not limited to, the IBM® Z/OS® operating system. (IBM, Z/OS and DS800 are registered trademarks of IBM throughout the world).

The command interface 114, resource manager 116, and service manager 124 may comprise program code loaded into a memory and executed by processors. Alternatively, some or all of the functions may be implemented as microcode or firmware in hardware devices in the storage controller 102 and hosts 100, such as in Application Specific Integrated Circuits (ASICs) and Field Programmable Gate Array (FPGA).

The storage 108 may comprise one or more storage devices, such as a solid state storage device (SSD) comprised of solid state electronics, NAND storage cells, EEPROM (Electrically Erasable Programmable Read-Only Memory), flash memory, flash disk, Random Access Memory (RAM) drive, storage-class memory (SCM), Phase Change Memory (PCM), resistive random access memory (RRAM), spin transfer torque memory (STM-RAM), conductive bridging RAM (CBRAM), magnetic hard disk drive, optical disk, tape, etc. The storage 108 may further be configured into an array of devices, such as Just a Bunch of Disks (JBOD), Direct Access Storage Device (DASD), Redundant Array of Independent Disks (RAID) array, virtualization device, etc. Further, the storage devices may comprise heterogeneous storage devices from different vendors or from the same vendor.

The memory 120 may comprise a suitable volatile or non-volatile memory devices, including those described above.

The network 104 may comprise a Storage Area Network (SAN), a Local Area Network (LAN), a Wide Area Network (WAN), the Internet, and Intranet, etc.

FIG. 2 illustrates an embodiment of an instance 200; of protected resource permissions, including: protected resource identifier 202 of a protected resource 115; privileged actions 204 comprising commands that can impact the protected resource 202 that must satisfy the security requirement 206 to execute to affect the protected resource 202; a security requirement 206 such as a required security level or a token that must be presented by the process, such as host or non-host process, to execute the privileged action 204; monitoring hosts 208 monitoring the protected resource 202, that may satisfy the security requirement 206; and an elevated permission protocol flag 210 that indicates whether elevated permission is available to provide to a requesting host 100_{R} to access the protected resource 202 that does not satisfy the security requirement 206.

The security requirement 206 may comprise a required token that must be presented when a privileged action 204 is submitted or comprise a minimum security level that a requesting host 100_{R} or other process must satisfy in order to allow the privileged action 204 to impact the protected resource 202.

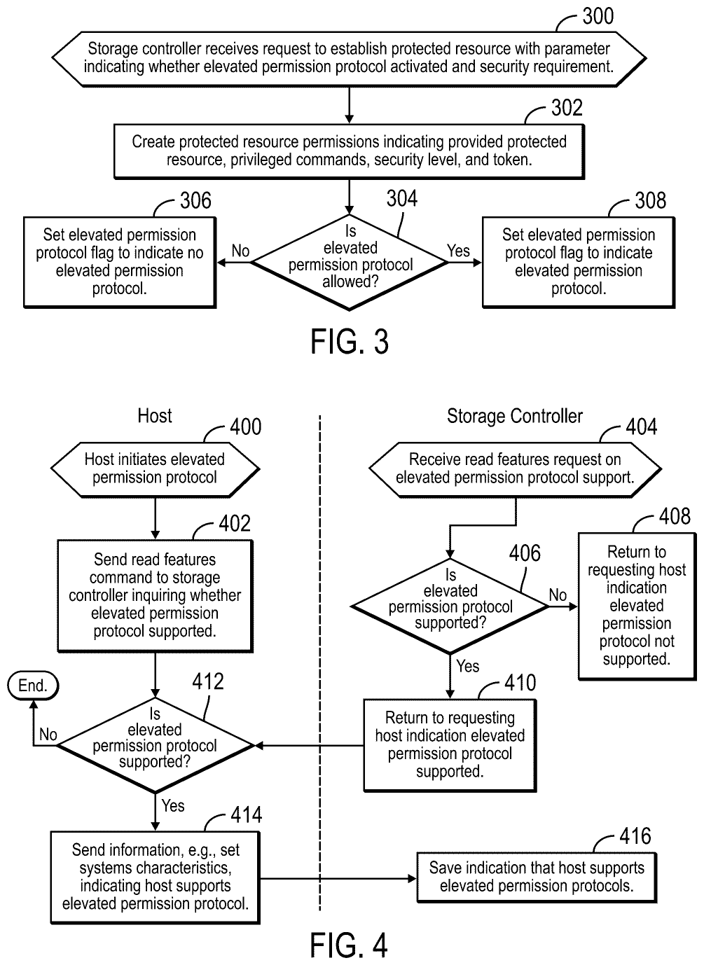

FIG. 3 illustrates an embodiment of operations performed by the service manager 124 to process a command, from a requesting host 100_{R} or other type of process, such as a non-host, to establish protection of a protected resource 115. This requesting host 100_{R} command may include as parameters a security requirement, privileged actions that must satisfy the security requirement, the protected resource 115, and a parameter indicating whether the elevated permission protocol is permitted for the protected resource 115 and a token to perform an indicated privileged command. Upon receiving (at block 300) a request to provide protection of a protected resource 115, the service manager 124 creates (at block 302) an instance of protected resource permissions 200; indicating the provided protected resource 202, privileged actions 204, and security requirement 206. If (at block 304) the request indicates to not allow the elevated permission protocol, then the elevated permission protocol flag 210 is set (at block 306) to indicate no elevated permission protocol. Otherwise, if (at block 304) the request indicates to allow the elevated permission protocol, then the elevated permission protocol flag 210 is set (at block 306) to indicate the elevated permission protocol is supported.

FIG. 4 illustrates a handshaking process between a requesting host 100_{R} and the storage controller 102 to establish the elevated permission protocol functionality between the host 100_{R} and the storage controller 102. Upon the host 100_{R}, such as a process of the host 100_{R}, initiating (at block 400) the elevated permission protocol, the host command interface 114 sends (at block 402) a read features command, or other request, to the storage controller 102 inquiring whether the elevated permission protocol is supported. If (at block 406) the storage controller 102 operating system 122 does not support the elevated permission protocol, then the service manager 124 returns (at block 408) status, such as a unit check, to the requesting host 100_{R} indicating that the elevated permission protocol is not supported. If (at block 406) the storage controller 102 operating system 122 supports the elevated permission protocol, then the service manager 124 returns (at block 408) status, such as a unit check, to the requesting host 100_{R} indicating that the elevated permission protocol is supported.

Upon the host 100_{R} receiving (at block 408) a status from the storage controller 102 indicating whether the elevated permission protocol is supported, if (at block 412) elevated permission protocol is not supported, then control ends. If (at block 412) the elevated permission protocol is supported, then the host 100_{R} sends (at block 414) information, e.g., a set systems characteristics command, indicating the host 100 also supports the elevated permission protocol. The service manager 124 then saves (at block 416) indication that host 100_{R} supports the elevated permission protocol in the host supporting elevated permission information 126.

With the embodiment of FIG. 4, the host 100 and storage controller 102 engage in a handshaking process to establish between each other that they both support the elevated permission protocol and may implement functionality and operations of the elevated permission protocol. This functionality provides improved efficiency to elevate the protection level of hosts to perform certain privileged actions impacting protected resources when such elevation is appropriate.

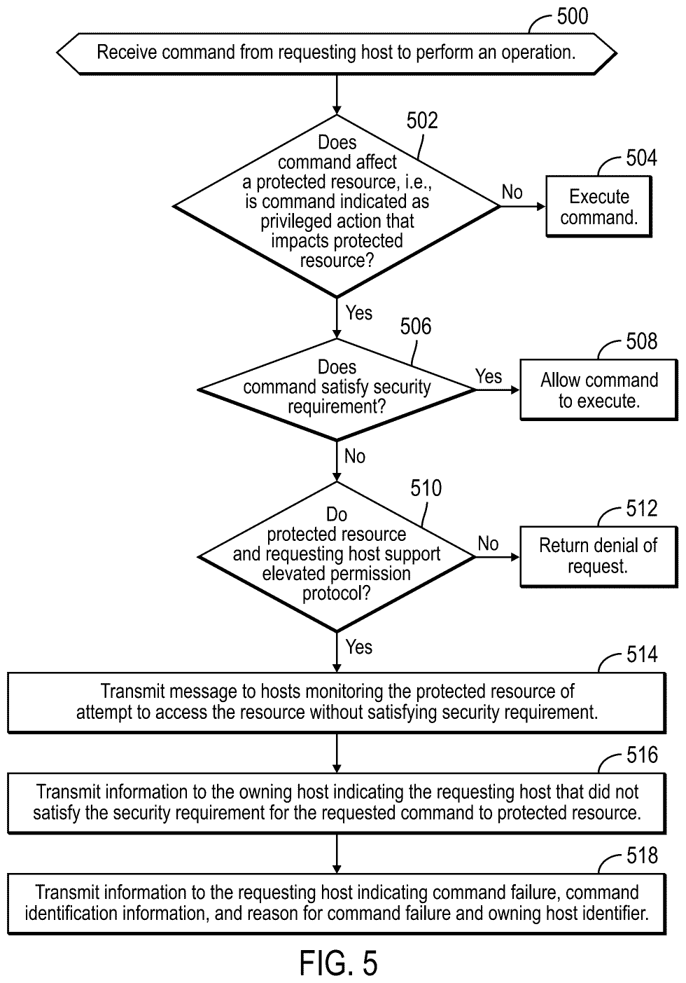

FIG. 5 illustrates an embodiment of operations performed by the service manager 124 at the storage controller 102 to process a request by a requesting host 100_{R}, such as a process of the requesting host 100_{R}, to perform a privileged command that affects a protected resource. Upon receiving (at block 500) a command from a requesting host 100_{R}, or other type of process, to perform an operation, if (at block 502) the command does not affect a protected resource 115, e.g., command is not indicated as privileged action 204 that impacting a protected resource 202 in in the protected resource permissions 200, then the requested command is executed (at block 504). If (at block 502) the command comprises a privileged command 204 affecting a protected resource 202, then the service manager 124 determines whether the command or requesting host 100_{R} satisfies (at block 506) the security requirement 206. Satisfying the security requirement may comprise the host command submitting a token established for the protected resource 115 or the requesting host 100_{R} being assigned a security level, indicated in service manager 124 information, that satisfies the security level requirement 206 of the protected resource 202, i.e., is at least as strong a security level.

If (at block 506) the command satisfies the security requirement 206, then the command is allowed (at block 508) to execute and impact the protected resource 202. If (at block 506) the command does not satisfy the security requirement 206, then the service manager 124 determines (at block 510) whether the protected resource 202, as indicated in elevated permission protocol flag 210, and the request host 100_{R}, as indicated in the hosts supporting elevated permission information 126, support the elevated permission protocol. If not, then the service manager 124 returns (at block 512) denial to the host command. If (at block 510) both the protected resource and the requesting host 100_{R} support the elevated permission protocol, then the service manager 124 may optionally transmit (at block 514) a message to hosts 100 monitoring the protected resource 202, indicated in field 208, of an attempt to access the protected resource 202 without satisfying the security requirement 206. The service manager 124 may further optionally transmit (at block 516) information to the owning host 100_{O} indicating the requesting host 100_{R} that did not satisfy the security requirement for the requested command to protected resource. The owning host 100_{O} may log this request or alternatively take further action, such as inform the service manager 124 to block granting elevated permission to the requesting host 100_{R} or inform the service manager 124 to grant the requesting host 100_{R} elevated permission to resubmit the command. An owning host 100_{O} comprises a host 100 that determines whether to grant elevated permission to a request host 100_{R} to submit a command impacting a requesting resource. The owning host 100_{O} may comprise the host 100 that established the protected resource 115.

The service manager 124 may further optionally transmit (at block 518) sense information to the requesting host 100_{R} indicating command failure, command identification information to enable the requesting host 100_{R} to identify the failed command, a reason for command failure and the owning host 100_{O} identifier. In an alternative embodiment, the service manager 124 may transmit status to the requesting host 100_{R} that the command failed, and the requesting host 100_{R} may then submit a request or query to the service manager 124 for the reason for the command failure. Upon receiving information on the failed command from the service manager 124, the requesting host 100_{R} may send a request to the owning host 100_{O} to grant elevated permission to allow the requesting host 100_{R} to resubmit the command to impact the protected resource.

With the embodiment of FIG. 5, the storage controller 102 may determine whether to use an elevated permission protocol to set into motion a series of operations to grant the requesting host 100_{R} elevated permission to submit a command to impact a protected resource 115 when the requesting host 100_{R} does not initially satisfy security requirements for the protected resource 115. This provides a mechanism for the host 100 to continue with necessary operations without having to fail a critical operation by elevating the host 100 ability to submit commands that impact protected resources.

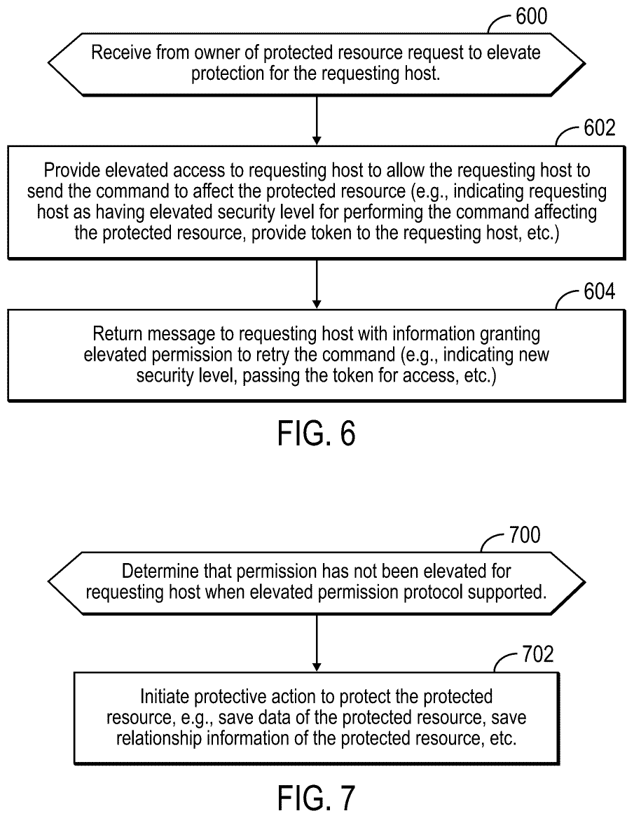

FIG. 6 illustrates an embodiment of operations performed by the service manager 124 upon receiving permission from the owning host 100_{O}, such as a process in the host 100_{O}, to allow the requesting host 100_{R} to submit a command that impacts the protected resource 115. The owning host 100_{O} may submit the granting of permission to the requesting host 100_{R} upon receiving the information the service manager 124 sends at block 516. Alternatively, the owning host 100_{O} may submit the granting of permission in response to the requesting host 100_{R} requesting the owning host 100_{O} to elevate the permission of the requesting host 100_{R}. Upon the service manager 124 receiving (at block 600) from the owning host 100_{O} a request to elevate permission for the requesting host, the service manager 124 provides (at block 602) the elevated permission to the requesting host 100_{R} to allow the requesting host 100_{R} to send the command that impacts the protected resource 115. To elevate permission, the service manager 124 may indicate the host as having an elevated security level for performing the command impacting the protected resource or provide a token to the requesting host 100_{R} to include when resubmitting the rejected command. The service manager 124 returns (at block 604) a message to the requesting host 100_{R} with information granting elevated permission to retry the command, such as informing the requesting host 100_{R} of the new security level assigned to the requesting host 100_{R} or passing a token for the requesting host 100_{R} to submit when retrying the command impacting the protected resource.

With the embodiment of FIG. 6, the owning host 100_{O} that established the permissions for the protected resource may determine which requesting hosts may have their permissions elevated to submit commands that impact the protected resource created by the owning host 100_{O}. This allows the owning host 100_{O} to control which hosts or command originators may impact the protected resource in a manner that could cause a relationship, comprising the protected resource, to fail.

FIG. 7 illustrates an embodiment of operations performed by the service manager 124 to take actions to protect a protected resource in response to elevated permission not being granted to the requesting host 100_{R}. Failure to elevate permission may occur when the requesting host 100_{R} is deemed potentially malicious. Upon determining (at block 700) that protection has not been elevated for the requesting host 100_{R}, or other process submitting the command, when the elevated permission protocol is supported, the service manager 124 initiates (at block 702) a protective action to secure the protected resource 115. Such protective action may comprise saving data of the protected resource 115, such as saving data included in a copy relationship, saving the relationship information, etc. In this way, the service manager 124 may protect data or resources in the storage controller 102 when the requesting host 100_{R} has not been able to successfully elevate its permission, which may occur when the requesting host 100_{R} is involved in malicious or unauthorized activity.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

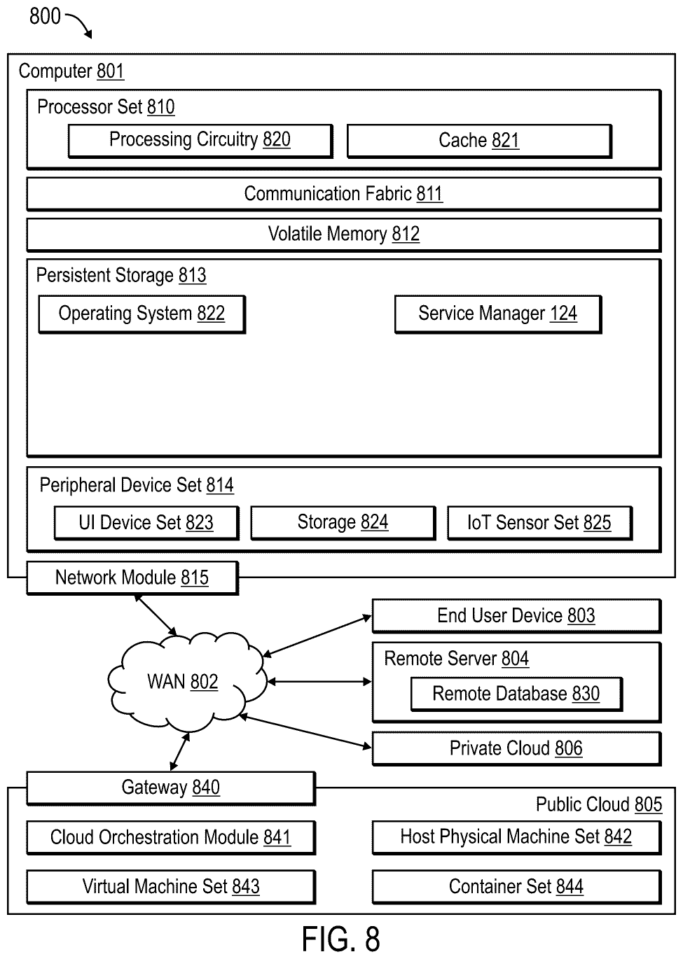

With respect to FIG. 8, computing environment 800 contains an example of an environment for the execution of at least some of the computer code involved in performing the inventive methods, such as providing a service manager 124, as disclosed above, in persistent storage 813, to support an elevated permission protocol to elevate host permission to issue a command that impacts a protected resource. The computing environment 800 further includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and service manager 124, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer-readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in persistent storage typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer-readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on. The EUD 803 may comprise the hosts 100, including the requesting host 100_{R} and owning hosts 100_{O}.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

CLOUD COMPUTING SERVICES AND/OR MICROSERVICES (not separately shown in FIG. 8): private and public clouds 806 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for managing access to a protected resource in a computing system, the computer program product comprising a computer readable storage medium having computer readable program code embodied therein that when executed performs operations, the operations comprising:
receiving a command from a first computer process to perform an operation effecting a protected resource in the computing system;
determining whether the command satisfies a security requirement of the protected resource;
in response to determining that the command does not satisfy the security requirement of the protected resource, transmitting information indicating that the command did not satisfy the security requirement for the protected resource to one of the first computer process or a second computer process controlling whether to elevate permission to the protected resource; and
providing the first computer process elevated permission to perform the command to affect the protected resource in response to the second computer process providing the elevated permission for the command from the first computer process to affect the protected resource.

2. The computer program product of claim 1, wherein the operations further comprise:
receiving a query, from the first computer process, requesting indication of whether elevated permission protocol is supported;
returning a response to the query indicating that the elevated permission protocol is supported; and
receiving information that the first computer process supports the elevated permission protocol, wherein the transmitting the information that the command did not satisfy the security requirement of the protected resource and the providing the first computer process the elevated permission are performed in response to receiving the response indicating the first computer process supports the elevated permission protocol.

3. The computer program product of claim 1, wherein the transmitted information is transmitted to the first computer process and includes information on why the command failed, identification information on the command to allow the first computer process to identify the command that failed, and information on the second computer process, wherein the first computer process uses the transmitted information to communicate with the second computer process to request elevated permissions for the command to affect the protected resource, wherein the operations further comprise:
receiving, from the second computer process, approval to elevate permission for the first computer process to submit the command that affects the protected resource, wherein the first computer process is provided the elevated permission in response to the approval to elevate permission received from the second computer process.

4. The computer program product of claim 1, wherein the transmitted information is transmitted to the second computer process and indicates the first computer process, the command, and the effected protected resource, wherein the operations further comprise:
receiving, from the second computer process, approval to elevate permission for the first computer process to submit the command that affects the protected resource, wherein the first computer process is provided the elevated permission in response to the receiving the approval to elevate permission.

5. The computer program product of claim 1, wherein the first computer process comprises a first host, and the second computer process comprises a second host that established the protected resource.

6. The computer program product of claim 1, wherein the operations further comprise:
determining hosts that registered to monitor the protected resource; and
transmitting notification to the determined hosts with information on the command from the first computer process that would affect the protected resource.

7. The computer program product of claim 1, wherein the protected resource comprises data, and wherein the operations further comprise:
determining that the elevated permission has not been granted to allow the first computer process to submit the command to affect the protected resource; and
initiating a protective action to protect the data of the protected resource in response to determining that the elevated permission is not provided to perform the command.

8. The computer program product of claim 1, wherein the command affects the protected resource by performing one of modifying data of the protected resource and causing a relationship of the protected resource to fail.

9. The computer program product of claim 1, wherein the operations further comprise:
receiving from the second computer process a request to create the protected resource, indication of whether elevated permission is allowed, and a token to provide permission to the protected resource; and
determining whether the elevated permission for the protected resource is allowed in response to determining that the command does not satisfy the security requirement of the protected resource, wherein the transmitting information that the command failed and the providing the first computer process the elevated permission are performed in response to determining that the elevated permission is allowed for the protected resource, wherein the providing the first computer process the elevated permission comprises providing the first computer process the token to the protected resource to use to resubmit the command affecting the protected resource.

10. A system for managing access to a protected resource in a computing system, comprising:
a processor; and
a computer readable storage medium having computer readable program code embodied therein that when executed performs:
receiving a command from a first computer process to perform an operation effecting a protected resource in the computing system;
determining whether the command satisfies a security requirement of the protected resource;
in response to determining that the command does not satisfy the security requirement of the protected resource, transmitting information indicating that the command did not satisfy the security requirement for the protected resource to one of the first computer process or a second computer process controlling whether to elevate permission to the protected resource; and
providing the first computer process elevated permission to perform the command to affect the protected resource in response to the second computer process providing the elevated permission for the command from the first computer process to affect the protected resource.

11. The system of claim 10, wherein the transmitted information is transmitted to the first computer process and includes information on why the command failed, identification information on the command to allow the first computer process to identify the command that failed, and information on the second computer process, wherein the first computer process uses the transmitted information to communicate with the second computer process to request elevated permissions for the command to affect the protected resource, wherein the operations further comprise:
receiving, from the second computer process, approval to elevate permission for the first computer process to submit the command that affects the protected resource, wherein the first computer process is provided the elevated permission in response to the approval to elevate permission received from the second computer process.

12. The system of claim 10, wherein the transmitted information is transmitted to the second computer process and indicates the first computer process, the command, and the effected protected resource, wherein the operations further comprise:
receiving, from the second computer process, approval to elevate permission for the first computer process to submit the command that affects the protected resource, wherein the first computer process is provided the elevated permission in response to the receiving the approval to elevate permission.

13. The system of claim 10, wherein the protected resource comprises data, and wherein the operations further comprise:
determining that the elevated permission has not been granted to allow the first computer process to submit the command to affect the protected resource; and
initiating a protective action to protect the data of the protected resource in response to determining that the elevated permission is not provided to perform the command.

14. The system of claim 10, wherein the command affects the protected resource by performing one of modifying data of the protected resource and causing a relationship of the protected resource to fail.

15. The system of claim 10, wherein the operations further comprise:
receiving from the second computer process a request to create the protected resource, indication of whether elevated permission is allowed, and a token to provide permission to the protected resource; and
determining whether the elevated permission for the protected resource is allowed in response to determining that the command does not satisfy the security requirement of the protected resource, wherein the transmitting information that the command failed and the providing the first computer process the elevated permission are performed in response to determining that the elevated permission is allowed for the protected resource, wherein the providing the first computer process the elevated permission comprises providing the first computer process the token to the protected resource to use to resubmit the command affecting the protected resource.

16. A method for managing access to a protected resource in a computing system, comprising:
receiving a command from a first computer process to perform an operation effecting a protected resource in the computing system;
determining whether the command satisfies a security requirement of the protected resource;
in response to determining that the command does not satisfy the security requirement of the protected resource, transmitting information indicating that the command did not satisfy the security requirement for the protected resource to one of the first computer process or a second computer process controlling whether to elevate permission to the protected resource; and
providing the first computer process elevated permission to perform the command to affect the protected resource in response to the second computer process providing the elevated permission for the command from the first computer process to affect the protected resource.

17. The method of claim 16, wherein the transmitted information is transmitted to the first computer process and includes information on why the command failed, identification information on the command to allow the first computer process to identify the command that failed, and information on the second computer process, wherein the first computer process uses the transmitted information to communicate with the second computer process to request elevated permissions for the command to affect the protected resource, further comprising:
receiving, from the second computer process, approval to elevate permission for the first computer process to submit the command that affects the protected resource, wherein the first computer process is provided the elevated permission in response to the approval to elevate permission received from the second computer process.

18. The method of claim 16, wherein the transmitted information is transmitted to the second computer process and indicates the first computer process, the command, and the effected protected resource, further comprising:
receiving, from the second computer process, approval to elevate permission for the first computer process to submit the command that affects the protected resource, wherein the first computer process is provided the elevated permission in response to the receiving the approval to elevate permission.

19. The method of claim 16, wherein the protected resource comprises data, further comprising:
determining that the elevated permission has not been granted to allow the first computer process to submit the command to affect the protected resource; and
initiating a protective action to protect the data of the protected resource in response to determining that the elevated permission is not provided to perform the command.

20. The method of claim 16, further comprising:
receiving from the second computer process a request to create the protected resource, indication of whether elevated permission is allowed, and a token to provide permission to the protected resource; and
determining whether the elevated permission for the protected resource is allowed in response to determining that the command does not satisfy the security requirement of the protected resource, wherein the transmitting information that the command failed and the providing the first computer process the elevated permission are performed in response to determining that the elevated permission is allowed for the protected resource, wherein the providing the first computer process the elevated permission comprises providing the first computer process the token to the protected resource to use to resubmit the command affecting the protected resource.
